(19) United States
(12) Patent Application Publication
(10) Pub. No.: US 2025/0259363 A1
(43) Pub. Date: Aug. 14, 2025

(54) VIDEO GENERATION METHOD AND APPARATUS

(71) Applicant: Beijing Zitiao Network Technology Co., Ltd., Beijing (CN)

(72) Inventors: Shupeng ZHANG, Beijing (CN); Bo ZHANG, Beijing (CN)

(21) Appl. No.: 18/857,110

(22) PCT Filed: Mar. 30, 2023
(86) PCT No.: PCT/CN2023/085074

§ 371 Date: Oct. 15, 2024

(30) Foreign Application Priority Data
Apr. 29, 2022 (CN) 202210476374.5

(51) Int. Cl. G06T 13/20; G06T 15/20; G06T 17/00; G06T 19/20

(52) U.S. Cl. CPC G06T 13/20; G06T 15/20; G06T 17/00; G06T 19/20; G06T 2200/24; G06T 2219/2004

(57) ABSTRACT

The embodiments of the present disclosure relate to the technical field of video production. Provided are a video generation method and apparatus. The method comprises: acquiring an initial pose of a virtual camera and a motion parameter of the virtual camera; determining at least one target camera pose of the virtual camera according to the initial pose and the motion parameter; rendering a target virtual scenario according to the at least one target camera pose, so as to acquire at least one video frame; and generating, according to the at least one video frame, a video to be generated.

### CROSS-REFERENCE TO RELATED APPLICATIONS

This application is based on and claims the benefit of priority of the International Patent Application No. PCT/CN2023/085074 and the Chinese application with application No. 202210476374.5, filed on Apr. 29, 2022, the disclosure content of which is hereby incorporated into this application in its entirety.

### TECHNICAL FIELD

The present disclosure relates to the technical field of video production, and in particular, to a video generation method and apparatus.

### BACKGROUND

Videos, as an important way of information dissemination, have a unique impact on social, economic, and cultural information communication. In addition to creating videos by shooting real scenes with video capture devices, people are also constantly pursuing video creation through virtual scenes.

### SUMMARY

Embodiments of the present disclosure provide technical solutions as follows.

In one aspect, an embodiment of the present disclosure provides a video generation method, including: acquiring an initial pose of a virtual camera and a motion parameter of the virtual camera;
determining at least one target camera pose of the virtual camera according to the initial pose and the motion parameter;
rendering a target virtual scene according to the at least one target camera pose, so as to acquire at least one video frame; and
generating, according to the at least one video frame, a video to be generated.

As an optional implementation of the embodiment of the present disclosure, before rendering a target virtual scene according to the at least one target camera pose so as to acquire at least one video frame, the method further includes:
constructing the target virtual scene;
wherein, the target virtual scene includes a virtual three-dimensional space and at least one target three-dimensional model disposed in the virtual three-dimensional space.

As an optional implementation of the embodiment of the present disclosure, the constructing the target virtual scene includes:
creating the virtual three-dimensional space;
determining the at least one target three-dimensional model; and
adding the at least one target three-dimensional model to a specified position in the virtual three-dimensional space.

As an optional implementation of the embodiment of the present disclosure, the determining the at least one target three-dimensional model includes:
displaying a model selection page, the model selection page displaying identifications of at least one three-dimensional model;
receiving a selection operation by a user on an identification of a three-dimensional model in the model selection page; and
determining the at least one target three-dimensional model based on the selection operation.

As an optional implementation of the embodiment of the present disclosure, the determining the at least one target three-dimensional model includes:
acquiring each storyboard of the video to be generated; and
constructing the at least one target three-dimensional model according to elements in each storyboard of the video to be generated.

As an optional implementation of the embodiment of the present disclosure, the method further includes: acquiring a transformation parameter of the at least one target three-dimensional model; and controlling the at least one target three-dimensional model to perform model state transformation in the virtual three-dimensional space according to the transformation parameter of the at least one target three-dimensional model.

As an optional implementation of the embodiment of the present disclosure, the rendering a target virtual scene according to the at least one target camera pose so as to acquire at least one video frame includes:
determining a model state corresponding to the at least one target camera pose; and
rendering the target virtual scene according to the at least one target camera pose and the model state corresponding to the at least one target camera pose, so as to acquire the at least one video frame.

As an optional implementation of the embodiment of the present disclosure, the generating a video to be generated according to the at least one video frame includes:
acquiring a background music for the video to be generated; and
encoding the at least one video frame and at least one audio frame of the background music based on a preset video encoding format to generate the video to be generated.

In another aspect, an embodiment of the present disclosure provides a video generation apparatus, including:
an acquisition unit, configured to acquire an initial pose of a virtual camera and a motion parameter of the virtual camera; and
a processing unit, configured to determine at least one target camera pose of the virtual camera according to the initial pose and the motion parameter;
a rendering unit, configured to render a target virtual scene according to the at least one target camera pose, so as to acquire at least one video frame; and
a generation unit, configured to generate a video to be generated according to the at least one video frame.

As an optional implementation of the embodiment of the present disclosure, the video generation apparatus further includes:
a construction unit, configured to, before rendering a target virtual scene according to the at least one target camera pose so as to acquire at least one video frame, construct the target virtual scene;
wherein, the target virtual scene includes a virtual three-dimensional space and at least one target three-dimensional model disposed in the virtual three-dimensional space.

As an optional implementation of the embodiment of the present disclosure, the construction unit is specifically configured to create the virtual three-dimensional space; determine the at least one target three-dimensional model; and add the at least one target three-dimensional model to a specified location in the virtual three-dimensional space.

As an optional implementation of the embodiment of the present disclosure, the construction unit is specifically configured to display a model selection page, the model selection page displaying identification of at least one three-dimensional model; receive a selection operation by a user on an identification of a three-dimensional model in the model selection page; and determine the at least one target three-dimensional model based on the selection operation.

As an optional implementation of the embodiment of the present disclosure, the construction unit is specifically configured to acquire each storyboard of the video to be generated; construct the at least one target three-dimensional model according to elements in each storyboard of the video to be generated.

As an optional implementation of the embodiment of the present disclosure, the construction unit is further configured to acquire a transformation parameter of the at least one target three-dimensional model; and control the at least one target three-dimensional model to perform model state transformation in the virtual three-dimensional space according to the transformation parameter of the at least one target three-dimensional model.

As an optional implementation of the embodiment of the present disclosure, the rendering unit is specifically configured to determine a model state corresponding to the at least one target camera pose; and render the target virtual scene according to the at least one target camera pose and the model state corresponding to the at least one target camera pose, so as to acquire the at least one video frame.

As an optional implementation of the embodiment of the present disclosure, the generating unit is specifically configured to acquire a background music for the video to be generated; and encode the at least one video frame and at least one audio frame of the background music based on a preset video encoding format to generate the video to be generated.

In another aspect, an embodiment of the present disclosure provides an electronic device, including: a memory and a processor, the memory is configured to store a computer program; the processor is configured to cause the electronic device to implement the video generation method described in any of the above implementations when executing the computer program.

In another aspect, an embodiment of the present disclosure provides a computer-readable storage medium, which, when executed by a computing device, causes the computing device to implement the video generation method described in any of the above implementations.

In another aspect, an embodiment of the present disclosure provides a computer program product, which, when run on a computer, causes the computer to implement the video generation method described in any of the above implementations.

The video generation method provided by the embodiments of the present disclosure first acquires an initial pose of a virtual camera and a motion parameter of the virtual camera, and determines at least one target camera pose of the virtual camera according to the initial pose and the motion parameter, then render a target virtual scene according to the at least one target camera pose, so as to acquire at least one video frame, and generate a video to be generated according to the at least one video frame.

### BRIEF DESCRIPTION OF THE DRAWINGS

The accompanying drawings, which are incorporated in and constitute a part of this specification, illustrate embodiments consistent with the disclosure and serve to explain the principles of the disclosure together with the description.

In order to more clearly illustrate technical solutions in the embodiments of the present disclosure or the related art, the accompanying drawings that need to be referred to in the description of the embodiments or the related art will be introduced briefly below. Apparently, for those of ordinary skilled in the art, other drawings may also be obtained from these drawings without any creative effort.

FIG. 1 is one of flow charts of steps of a video generation method provided by an embodiment of the present disclosure;

FIG. 2 is a schematic diagram of a target virtual scene provided by an embodiment of the present disclosure;

FIG. 3 is another flow chart of steps of a video generation method provided by an embodiment of the present disclosure;

FIG. 4 is a schematic diagram of model state transformation provided by an embodiment of the present disclosure;

FIG. 5 is one of schematic structural diagrams of a video generation apparatus provided by an embodiment of the present disclosure;

FIG. 6 is another schematic structure diagram of a video generation apparatus provided by an embodiment of the present disclosure;

FIG. 7 is a schematic diagram of a hardware structure of an electronic device provided by an embodiment of the present disclosure.

### DETAILED DESCRIPTION

In order to understand the above features and advantages of the present disclosure more clearly, the solution of the present disclosure will be further described below. It should be noted that the embodiments of the present disclosure and the features in the embodiments can be combined with each other as long as there is no conflict.

Many specific details are set forth in the following description to fully understand the present disclosure, but the present disclosure can also be implemented in other ways different from those described herein; obviously, the embodiments in the specification are only a part, not all, of embodiments of the present disclosure.

In the embodiments of the present disclosure, words such as “exemplary” or “for example” are used to represent serving as an example, exemplification or illustration. Any embodiment or design solutions described as “exemplary” or “for example” in the embodiments of the disclosure should not be construed as preferred or advantageous over other embodiments or design solutions. More exactly, the referring of words such as “exemplary” or “for example” is intended to present related concepts in a specific manner. In addition, in the description of the embodiments of the present disclosure, the meaning of “a plurality of” refers to two or more, unless otherwise specified.

In related arts, when creating a video based on a virtual scene, a video creator needs to make each video frame of the video independently, and then combine the individual video frames into the video. For example, when an animated short film is to be made, each frame of animation scene needs to be made separately. Even if it is the same scene from different perspectives, the scene cannot be reused. Instead, they need to be made independently, and the individual video frames are combined into the animated short film at last. As mentioned above, in related arts, when creating a video based on a virtual scene, each video frame of the video needs to be made independently, which is time-consuming, labor-intensive and inefficient.

In view of this, embodiments of the present disclosure provide a video generation method and apparatus to solve the problems of time-consuming, labor-intensive and inefficient in related arts when creating a video based on a virtual scene.

An embodiment of the present disclosure provides a video generation method. As shown in FIG. 1, the video generation method includes steps S11 to S14 as follows.

S11, acquiring an initial pose of a virtual camera and a motion parameter of the virtual camera.

In order to facilitate understanding of rendering a virtual scene to acquire corresponding images, in the embodiments of the present disclosure, the virtual scene is analogized to a real scene, and a virtual camera is created in the virtual scene that is analogous to collecting images of the real scene, thereby making it more convenient and quicker to determine an angle of view used when rendering a virtual scene. Therefore, a pose of a virtual camera in the embodiments of the present disclosure is used to characterize an angle of view used when rendering a virtual scene, similar to a pose of a real camera when the camera collects images of a real scene, and an initial pose of the virtual camera is then used to characterize an angle of view used by a first video frame obtained by rendering a target virtual scene. In some embodiments, the pose of the virtual camera may include position coordinates of the virtual camera in the virtual scene and a rotation angle of the virtual camera.

In the embodiment of the present disclosure, a motion parameter of a virtual camera is used to describe a motion mode of the virtual camera in a virtual three-dimensional space. In some embodiments, the motion parameter of the virtual camera includes at least one of a motion trajectory of the virtual camera, a motion direction of the virtual camera, a motion speed of the virtual camera, a rotation direction of the virtual camera, a rotation speed of the virtual camera, and the like.

S12, determining at least one target camera pose of the virtual camera according to the initial pose and the motion parameter.

In some embodiments, the implementation of the above step S12 (determining at least one target camera pose of the virtual camera according to the initial pose and the motion parameter) may include steps a and b as follows.

Step a, determining a time corresponding to each video frame to be generated.

Step b, determining at least one target camera pose according to the time corresponding to each video frame to be generated and the motion parameter.

Exemplarily, the frame rate of a video to be generated is 50 frames/second, and each video frame of the video to be generated is a video frame to be generated. An initial pose of a virtual camera includes: initial position coordinates (x0, y0, z0) and an initial rotation angle α°. A virtual camera motion parameter includes uniform linear motion along the x-axis at a speed of 100/second. Then, from the frame rate of the video to be generated, times corresponding to each video frame to be generated may be calculated as in turn at 0.00 second, 0.02 second, 0.04 second, 0.06 second, 0.08 second . . . , and then according to the time corresponding to each video frame to be generated and the motion parameter, position coordinates of a target camera pose are determined to include (x0, y0, z0), (x0+2, y0, z0), (x0+4, y0, z0), (x0+6, y0, z0), (x0+8, y0, z0) . . . , and rotation angles of individual target camera pose are all α°.

S13, rendering a target virtual scene according to the at least one target camera pose, so as to acquire at least one video frame.

In some embodiments, before the above step S13 (rendering a target virtual scene according to the at least one target camera pose so as to acquire at least one video frame), the video generation method provided by the embodiment of the present disclosure further includes constructing the target virtual scene.

Wherein, the target virtual scene includes a virtual three-dimensional space and at least one target three-dimensional model disposed in the virtual three-dimensional space.

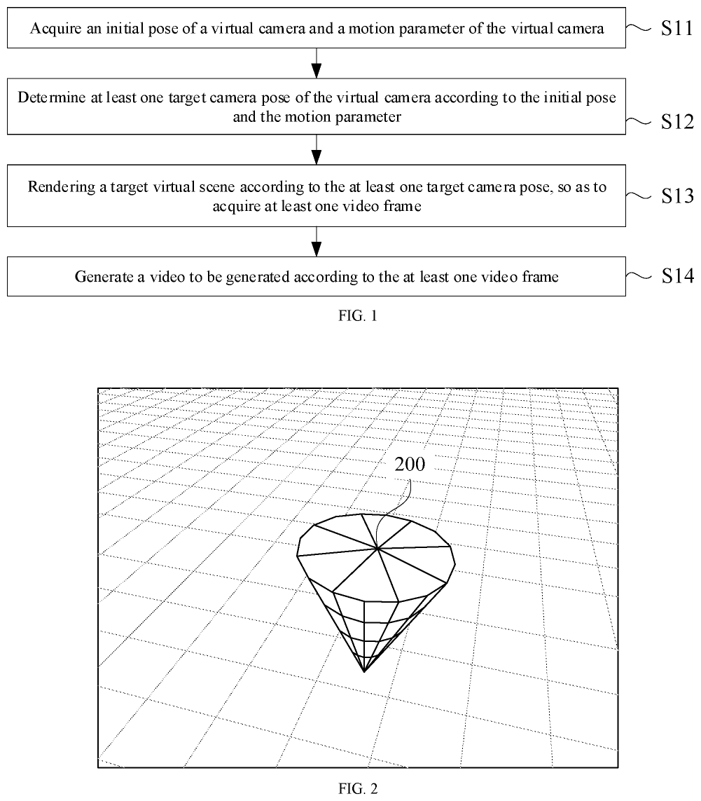

The target virtual scene in the embodiment of the present disclosure may be any virtual scene. For example, the target virtual scene may be a clothing display scene constructed from a virtual space and elements such as a three-dimensional clothing model and a three-dimensional humanoid dressing model located in the virtual space. For another example, the target virtual scene may be a vehicle display scene constructed from a virtual space and elements such as a three-dimensional vehicle model located in the virtual space. Exemplarily, referring to FIG. 2, FIG. 2 is shown by taking a constructed target virtual scene including a virtual three-dimensional space and a three-dimensional model 200 of a cone disposed in the virtual three-dimensional space as an example.

In the above step S13, rendering a target virtual scene according to the at least one target camera pose so as to acquire at least one video frame means rendering the target virtual scene according to each target camera pose so as to acquire a video frame corresponding to each target camera pose.

S14, generating a video to be generated according to the at least one video frame.

That is, the at least one video frame is encoded into the video to be generated.

It should be noted that generating a video to be generated according to the at least one video frame may be generating the video to be generated only according to the at least one video frame, or generating the video to be generated according to at least one video frame and video frames in a preset video clip. For example, the at least one video frame is inserted into the preset video clip to acquire the video to be generated.

As an optional implementation of the disclosure, the above step S14 (generating a video to be generated according to the at least one video frame) includes:
acquiring a background music for the video to be generated; and
encoding the at least one video frame and at least one audio frame of the background music based on a preset video encoding format to generate the video to be generated.

Furthermore, after generating the video to be generated, optimization operations such as adding subtitles and editing may also be performed on the video to be generated.

The video generation method provided by the embodiments of the present disclosure first acquires an initial pose of a virtual camera and a motion parameter of the virtual camera, and determines at least one target camera pose of the virtual camera according to the initial pose and the motion parameter, then render a target virtual scene according to the at least one target camera pose, so as to acquire at least one video frame, and generate a video to be generated according to the at least one video frame. Since the video frames to be generated in the embodiment of the present disclosure are obtained by rendering the target virtual scene according to the target camera pose, there is no need to independently build a scene model corresponding to each video frame. Therefore, the embodiment of the present disclosure may solve the problem of time-consuming, labor-intensive and inefficient in related arts when creating a video based on a virtual scene, thereby improving the efficiency of video creation based on a target virtual scene.

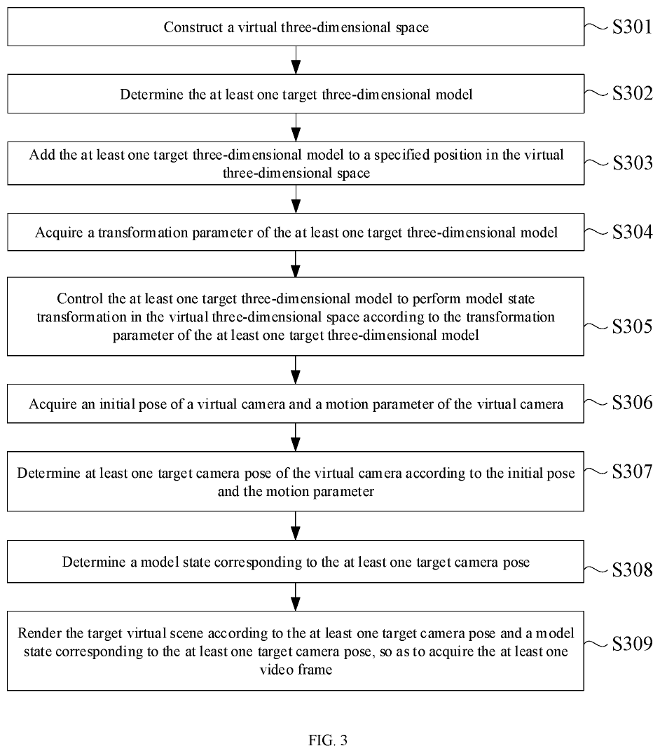

As an expansion and refinement of the above embodiment, an embodiment of the present disclosure provide another video generation method. As shown in FIG. 3, the video generation method includes steps S301 to S309 as follows.

S301, constructing a virtual three-dimensional space.

The virtual three-dimensional space constructed in the embodiment of the present disclosure may be a three-dimensional space of any size and shape.

S302, determining the at least one target three-dimensional model.

There may be any number of three-dimensional models in the embodiment of the present disclosure, and the three-dimensional model may be a three-dimensional model of any physical object. For example, the three-dimensional model may be a human body model, an animal model, a virtual clothing model, etc.

As an optional implementation of the embodiment of the present disclosure, the implementation of the above step S302 (determining the at least one target three-dimensional model) may include steps 1 to 3 as follows.

Step 1, displaying a model selection page.

Wherein, the model selection page displays an identification of at least one three-dimensional model.

That is, the three-dimensional models that may be provided to a user for selection are displayed in the model selection interface so that the user may make a selection.

Step 2, receiving a selection operation by a user on an identification of a three-dimensional model in the model selection page.

The selection operation in the embodiment of the present disclosure may be an operation input by the user through a mouse on the model selection page, or may be a touch operation by the user, or may also be a voice operation by the user, the type of which is not limited in the embodiment of the present disclosure, as long as being able to determine the three-dimensional model that the user wants to select through the selection operation.

Step 3, determining the at least one target three-dimensional model based on the selection operation.

For example, the model selection page displays three-dimensional model A, three-dimensional model B, three-dimensional model C, three-dimensional model D and three-dimensional model F. If a user inputs a selection operation for three-dimensional model A and three-dimensional model C on the model selection page, the three-dimensional model A and three-dimensional model C will be determined as target three-dimensional models.

As an optional implementation of the embodiment of the present disclosure, the implementation of determining the at least one target three-dimensional model may include steps I and II as follows.

Step I, acquiring each storyboard of the video to be generated.

Storyboard, also known as storyboarding, refers to a file that explains composition of a film medium such as videos, movies, animations, TV series, and advertisements in a specific way before actual shooting or drawing the film. Specifically, in the embodiment of the present disclosure, it is a picture and a camera angle that needs to be highlighted.

Step II, constructing the at least one target three-dimensional model according to elements in each storyboard of the video to be generated.

For example, storyboard 1 of a video to be generated includes virtual character 1 and virtual clothing 1, storyboard 2 of the video to be generated includes virtual character 2 and virtual clothing 2, then a three-dimensional model corresponding to virtual character 1, a three-dimensional model corresponding to virtual clothing 1, a three-dimensional model corresponding to virtual character 2 and a three-dimensional model corresponding to virtual clothing 2 are constructed, and the three-dimensional model corresponding to virtual character 1, the three-dimensional model corresponding to virtual clothing 1, the three-dimensional model corresponding to virtual character 2 and the three-dimensional model corresponding to virtual clothing 2 are determined as the target three-dimensional model.

S303, adding the at least one target three-dimensional model to a specified position in the virtual three-dimensional space.

Optionally, the implementation of the above step S303 (adding the at least one target three-dimensional model to a specified position in the virtual three-dimensional space) may include:
displaying the target virtual scene and the at least one target three-dimensional model;
receiving a drag operation on the at least one target three-dimensional model by a user;
in response to the drag operation, adding the at least one target three-dimensional model to a specified position in the virtual three-dimensional space.

S304, acquiring a transformation parameter of the at least one target three-dimensional model.

In the embodiment of the present disclosure, the transformation parameter of a three-dimensional model are used to describe a transformation method of each three-dimensional model in a virtual three-dimensional space.

For example, when a target three-dimensional model includes a three-dimensional human body model and a three-dimensional clothing model, the transformation parameter of the three-dimensional model may include a parameter used to describe state transformation of the three-dimensional human body model during walking and a parameter used to describe state transformation of the three-dimensional clothing model simulation of the three-dimensional human body model.

S305, controlling the at least one target three-dimensional model to perform model state transformation in the virtual three-dimensional space according to the transformation parameter of the at least one target three-dimensional model.

It should be noted that in the embodiment of the present disclosure, the model state transformation includes transformation of a position of a three-dimensional model in a virtual three-dimensional space and/or transformation of a post of a three-dimensional model.

S306, acquiring an initial pose of a virtual camera and a motion parameter of the virtual camera.

S307, determining at least one target camera pose of the virtual camera according to the initial pose and the motion parameter.

S308, determining a model state corresponding to the at least one target camera pose.

In some embodiments, the implementation of step S308 (determining a model state corresponding to the at least one target camera pose) may comprise steps (1) and (2) as follows:

Step (1), determining a time corresponding to each target camera pose.

Step (2), calculating a model state corresponding to the at least one target camera pose according to the time corresponding to each target camera pose and a transformation parameter of the at least one target three-dimensional model.

Exemplarily, an initial model state of a three-dimensional model is shown in FIG. 2, an initial position is (x2, y2, z2) and a rotation angle is 0°; the times corresponding to target camera poses are in turn at 0.00 second, 0.02 second, 0.04 second, 0.06 second, 0.08 second . . . , the transformation parameter of the three-dimensional model includes rotating at a uniform speed in the three-dimensional space at a rotation of 90°/second, and moving in a straight line at a uniform speed along the y-axis direction at a speed of 50/second. Then, as shown in FIG. 4, the model state corresponding to each target camera pose may be calculated according to the time corresponding to each target camera pose and the transformation parameter of the at least one target three-dimensional model, including (x2, y2, z2) and the rotation angle of 0°, (x2, y2+1, z2) and the rotation angle of 1.8°, (x2, y2+2, z2) and the rotation angle of 3.6°, (x2, y2+3, z2) and the rotation angle of 5.4°.

S309, rendering the target virtual scene according to the at least one target camera pose and a model state corresponding to the at least one target camera pose, so as to acquire the at least one video frame.

Based on the same inventive concept, as an implementation of the above method, an embodiment of the present disclosure further provides a video generation apparatus. This embodiment corresponds to the foregoing method embodiment. For ease of reading, this embodiment will not elaborate on the details of the foregoing method embodiments one by one, but it should be clear that the video generation apparatus in this embodiment can correspondingly implement all the contents of the foregoing method embodiments.

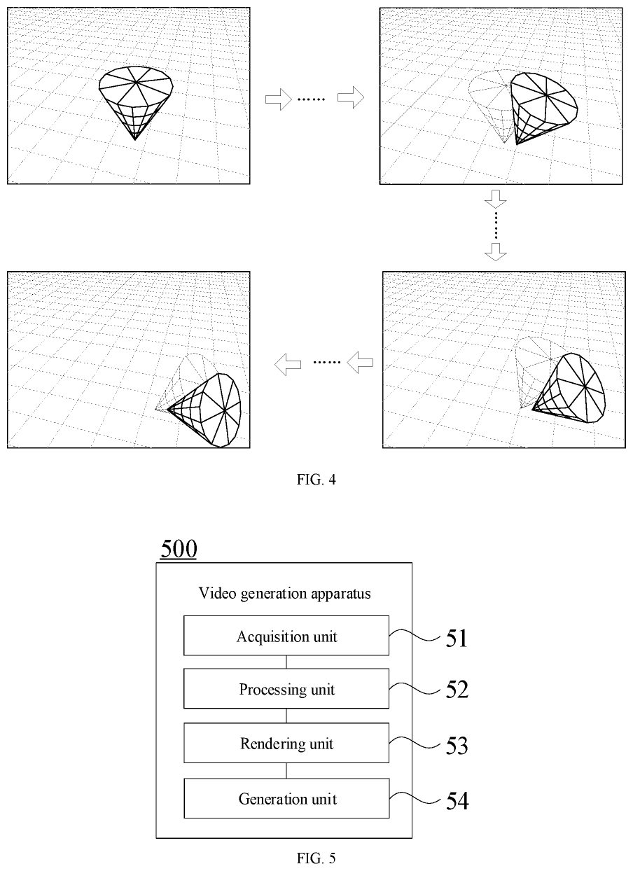

An embodiment of the present disclosure provides a video generation apparatus. FIG. 5 is a schematic structural diagram of the video generation apparatus. As shown in FIG. 5, the video generation apparatus 500 includes:
an acquisition unit 51, configured to acquire an initial pose of a virtual camera and a motion parameter of the virtual camera; and
a processing unit 52, configured to determine at least one target camera pose of the virtual camera according to the initial pose and the motion parameter;
a rendering unit 53, configured to render a target virtual scene according to the at least one target camera pose, so as to acquire at least one video frame; and
a generation unit 54, configured to generate a video to be generated according to the at least one video frame.

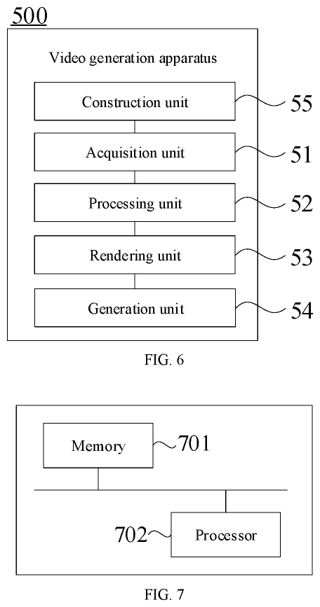

As an optional implementation of the embodiment of the present disclosure, with reference to FIG. 6, the video generation apparatus 500 further includes:
a construction unit 55, configured to, before rendering a target virtual scene according to the at least one target camera pose so as to acquire at least one video frame, construct the target virtual scene;
wherein, the target virtual scene includes a virtual three-dimensional space and at least one target three-dimensional model disposed in the virtual three-dimensional space.

As an optional implementation of the embodiment of the present disclosure, the construction unit 55 is specifically configured to create the virtual three-dimensional space; determine the at least one target three-dimensional model; and add the at least one target three-dimensional model to a specified location in the virtual three-dimensional space.

As an optional implementation of the embodiment of the present disclosure, the construction unit 55 is specifically configured to display a model selection page, the model selection page displaying identification of at least one three-dimensional model; receive a selection operation by a user on an identification of a three-dimensional model in the model selection page; and determine the at least one target three-dimensional model based on the selection operation.

As an optional implementation of the embodiment of the present disclosure, the construction unit 55 is specifically configured to acquire each storyboard of the video to be generated; construct the at least one target three-dimensional model according to elements in each storyboard of the video to be generated.

As an optional implementation of the embodiment of the present disclosure, the construction unit 55 is further configured to acquire a transformation parameter of the at least one target three-dimensional model; and control the at least one target three-dimensional model to perform model state transformation in the virtual three-dimensional space according to the transformation parameter of the at least one target three-dimensional model.

As an optional implementation of the embodiment of the present disclosure, the rendering unit 53 is specifically configured to determine a model state corresponding to the at least one target camera pose; and render the target virtual scene according to the at least one target camera pose and the model state corresponding to the at least one target camera pose, so as to acquire the at least one video frame.

As an optional implementation of the embodiment of the present disclosure, the generating unit 54 is specifically configured to acquire a background music for the video to be generated; and encode the at least one video frame and at least one audio frame of the background music based on a preset video encoding format to generate the video to be generated.

The video generation apparatus provided in the embodiment may execute the video generation method provided in the above method embodiment. Their implementation principles and technical effects are similar and will not be repeated here again.

Based on the same inventive concept, an embodiment of the present disclosure further provides an electronic device. FIG. 7 is a schematic structural diagram of an electronic device provided by an embodiment of the present disclosure. As shown in FIG. 7, the electronic device provided by the embodiment includes: a memory 701 and a processor 702, wherein the memory 701 is configured to store a computer program; the processor 702 is configured to, when executing the computer program, execute the video generation method provided by the above embodiments.

Based on the same inventive concept, an embodiment of the present disclosure further provides a computer-readable storage medium having a computer program stored thereon, which, when executed by a processor, causes the computing device to implement the video generation method provided by the above embodiments.

Based on the same inventive concept, an embodiment of the present disclosure further provides a computer program product, which, when run on a computer, causes the computing device to implement the video generation method provided in the above embodiments.

Those skilled in the art will appreciate that embodiments of the present disclosure may be provided as methods, systems, or computer program products. Thus, the present disclosure may take the form of an entirely hardware embodiment, an entirely software embodiment, or an embodiment combining software and hardware aspects. Furthermore, the present disclosure may take the form of a computer program product embodied on one or more computer-usable storage media having computer-usable program code contained therein.

The processor may be a Central Processing Unit (CPU), other general-purpose processor, a Digital Signal Processor (DSP), an Application Specific Integrated Circuit (ASIC), or a Field-Programmable Gate Array (FPGA) or other programmable logic device, a discrete gate or transistor logic device, a discrete hardware component, etc. A general-purpose processor may be a microprocessor or the processor may be any conventional processor, etc.

The memory may include the form of a non-persistent memory, a random access memory (RAM) and/or a non-volatile memory, etc. in computer-readable media, for example, a read-only memory (ROM) or a flash RAM. The memory is an example of computer-readable media.

The computer-readable media include persistent and non-persistent, removable and non-removable storage media. The storage media may be implemented by any method or technology to store information, and the information may be computer-readable instructions, data structures, program modules, or other data. Examples of computer storage media include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a magnetic tape cassette, a magnetic disk storage or other magnetic storage devices or any other non-transmission medium, which can be used to store information that can be accessed by a computing device. The computer-readable media, as defined herein, exclude transitory media, such as modulated data signals and carrier waves.

Finally, it should be noted that the above embodiments are only used to illustrate the technical solutions of the present disclosure, but not to limit them; although the present disclosure has been described in detail with reference to the foregoing embodiments, those of ordinary skill in the art should understand that: the technical solutions recited in the foregoing embodiments can still be modified, or some or all of the technical features thereof can be equivalently substituted; and these modifications or substitutions do not make the essence of the corresponding technical solutions deviate from the range of the technical solutions of the embodiments of the present disclosure.

1. A video generation method, comprising:
acquiring an initial pose of a virtual camera and a motion parameter of the virtual camera;
determining at least one target camera pose of the virtual camera according to the initial pose and the motion parameter;
rendering a target virtual scene according to the at least one target camera pose, so as to acquire at least one video frame; and
generating, according to the at least one video frame, a video.

2. The method according to claim 1, wherein, before rendering a target virtual scene according to the at least one target camera pose so as to acquire at least one video frame, the method further comprises:
constructing the target virtual scene;
wherein, the target virtual scene comprises a virtual three-dimensional space and at least one target three-dimensional model disposed in the virtual three-dimensional space.

3. The method according to claim 2, wherein the constructing the target virtual scene comprises:
creating the virtual three-dimensional space;
determining the at least one target three-dimensional model; and
adding the at least one target three-dimensional model to a specified position in the virtual three-dimensional space.

4. The method according to claim 3, wherein the determining the at least one target three-dimensional model comprises:
displaying a model selection page, the model selection page displaying identifications of at least one three-dimensional model;
receiving a selection operation by a user on an identification of a three-dimensional model in the model selection page; and
determining the at least one target three-dimensional model based on the selection operation.

5. The method according to claim 3, wherein the determining the at least one target three-dimensional model comprises:
acquiring each storyboard of the video; and
constructing the at least one target three-dimensional model according to elements in each storyboard of the video.

6. The method according to claim 1, wherein the method further comprises:
acquiring a transformation parameter of the at least one target three-dimensional model; and
controlling the at least one target three-dimensional model to perform model state transformation in the virtual three-dimensional space according to the transformation parameter of the at least one target three-dimensional model.

7. The method according to claim 6, wherein the rendering a target virtual scene according to the at least one target camera pose so as to acquire at least one video frame comprises:
determining a model state corresponding to the at least one target camera pose; and
rendering the target virtual scene according to the at least one target camera pose and the model state corresponding to the at least one target camera pose, so as to acquire the at least one video frame.

8. The method according to claim 1, wherein the generating a video according to the at least one video frame comprises:
acquiring a background music for the video; and
encoding the at least one video frame and at least one audio frame of the background music based on a preset video encoding format to generate the video.

9. (canceled)

10. An electronic device, comprising: a memory and a processor, the memory is configured to store a computer program; the processor is configured to cause the electronic device to implement a video generation method of when executing the computer program, the video generation method comprises:
acquiring an initial pose of a virtual camera and a motion parameter of the virtual camera;
determining at least one target camera pose of the virtual camera according to the initial pose and the motion parameter;
rendering a target virtual scene according to the at least one target camera pose, so as to acquire at least one video frame; and
generating, according to the at least one video frame, a video.

11. A non-transient computer-readable storage medium having a computer program stored thereon, which, when executed by a computing device, causes the computing device to implement a video generation method comprising:
acquiring an initial pose of a virtual camera and a motion parameter of the virtual camera;
determining at least one target camera pose of the virtual camera according to the initial pose and the motion parameter;
rendering a target virtual scene according to the at least one target camera pose, so as to acquire at least one video frame; and
generating, according to the at least one video frame, a video.

12. (canceled)

13. (canceled)

14. The electronic device according to claim 10, wherein, before rendering a target virtual scene according to the at least one target camera pose so as to acquire at least one video frame, the method further comprises:
constructing the target virtual scene;
wherein, the target virtual scene comprises a virtual three-dimensional space and at least one target three-dimensional model disposed in the virtual three-dimensional space.

15. The electronic device according to claim 14, wherein the constructing the target virtual scene comprises:
creating the virtual three-dimensional space;
determining the at least one target three-dimensional model; and
adding the at least one target three-dimensional model to a specified position in the virtual three-dimensional space.

16. The electronic device according to claim 15, wherein the determining the at least one target three-dimensional model comprises:
displaying a model selection page, the model selection page displaying identifications of at least one three-dimensional model;
receiving a selection operation by a user on an identification of a three-dimensional model in the model selection page; and
determining the at least one target three-dimensional model based on the selection operation.

17. The electronic device according to claim 15, wherein the determining the at least one target three-dimensional model comprises:
acquiring each storyboard of the video; and
constructing the at least one target three-dimensional model according to elements in each storyboard of the video.

18. The electronic device according to claim 10, wherein the method further comprises:
acquiring a transformation parameter of the at least one target three-dimensional model; and
controlling the at least one target three-dimensional model to perform model state transformation in the virtual three-dimensional space according to the transformation parameter of the at least one target three-dimensional model.

19. The electronic device according to claim 18, wherein the rendering a target virtual scene according to the at least one target camera pose so as to acquire at least one video frame comprises:
determining a model state corresponding to the at least one target camera pose; and
rendering the target virtual scene according to the at least one target camera pose and the model state corresponding to the at least one target camera pose, so as to acquire the at least one video frame.

20. The electronic device according to claim 10, wherein the generating a video according to the at least one video frame comprises:
acquiring a background music for the video; and
encoding the at least one video frame and at least one audio frame of the background music based on a preset video encoding format to generate the video.

21. The non-transient computer-readable storage medium according to claim 11, wherein, before rendering a target virtual scene according to the at least one target camera pose so as to acquire at least one video frame, the method further comprises:
constructing the target virtual scene;
wherein, the target virtual scene comprises a virtual three-dimensional space and at least one target three-dimensional model disposed in the virtual three-dimensional space.

22. The non-transient computer-readable storage medium according to claim 21, wherein the constructing the target virtual scene comprises:
creating the virtual three-dimensional space; determining the at least one target three-dimensional model; and adding the at least one target three-dimensional model to a specified position in the virtual three-dimensional space.

23. The non-transient computer-readable storage medium according to claim 22, wherein the determining the at least one target three-dimensional model comprises:
displaying a model selection page, the model selection page displaying identifications of at least one three-dimensional model;
receiving a selection operation by a user on an identification of a three-dimensional model in the model selection page; and
determining the at least one target three-dimensional model based on the selection operation.
